(19) United States
(12) Patent Application Publication
(10) Pub. No.: US 2008/0078283 A1
(43) Pub. Date: Apr. 3, 2008

(54) Parameter setting apparatus

(75) Inventors: Kojiro Kato, Hamamatsu-Shi (JP); Takeshi Ando, Hamamatsu-shi (JP); Ryotaro Sugimoto, Hamamatsu-shi (JP); Akiko Shinjo, Hamamatsu-shi (JP); Seiji Abe, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/888,804

(22) Filed: Aug. 1, 2007

(30) Foreign Application Priority Data
Sep. 28, 2006 (JP) 2006-265152

(51) Int. Cl. G10H 7/00

(52) U.S. Cl. 84/625

(57) ABSTRACT

A parameter setting portion B11 sets control parameters in accordance with respective position of operators 41 of movable operating devices 40A, 40B, and delivers the control parameters to a utilization apparatus 24. A target position move control portion B12 controls a motor 45 provided in the movable operating devices 40A, 40B in accordance with target position data stored in a target position storage portion B13 to automatically move the operators 41 to their respective target positions. An operational resistance control portion B14 imparts a resistance to a manipulation of the operator 41 in accordance with the position of the operator 41 by use of a resistance table stored in a resistance storage portion B15. The resistance continuously increases with increasing distance of the operator 41 from its target position or with increasing approach of the operator 41 to its avoidance position.

### BACKGROUND OF THE INVENTION

1. Field of the Invention

The present invention relates to a parameter setting apparatus having movable operating devices for outputting signals indicative of the position of operators which are moved by manual operation, the parameter setting apparatus setting control parameters in accordance with the position of the operators.

2. Description of the Related Art

As such a parameter setting apparatus, sound mixers have been well known. The sound mixers, which have a plurality of faders (equivalent to the operators in the present invention), specify the output level of a plurality of signals in accordance with the respective positions of the faders. As shown in Japanese Patent Laid-Open Publication No. 2004-247898, particularly, recent sound mixers are capable of switching functions assigned to the respective faders. In addition, the recent sound mixers are provided with a motorized actuator for actuating the faders to allow the faders to be automatically moved to a previously specified position in accordance with conditions. Such automatic settings on the faders are hereafter referred to as scene call.

### SUMMARY OF THE INVENTION

The above-described conventional sound mixers allow a user to displace the faders at will even after the scene call, however, the displacement of the faders can lose the set balance of the faders. If the user has intentionally displaced the faders, there is no problem. If not, however, the impaired balance presents problems. In addition, it is difficult for the user to recover the impaired balance. If the user manipulates the faders in an attempt to recover the impaired balance, the user's attempt can further impair the balance.

Not only in the scene call but also in other cases, when the faders (movable operating devices) are used for specific functions, positions where the operators are expected to be positioned or expected to avoid are provided in some cases. In other words, the problem which arises in the sound mixers when the faders are used for the control of the output level of signals can similarly arise in the sound mixers when the faders are used for the control of sound effects to be added by the sound mixers. Furthermore, the above-described problem can arise not only in the sound mixers but also in musical tone signal generating apparatuses which generate musical tone signals including electronic musical instruments when the output level of musical tone signals, effects and the like are controlled through the use of movable operating devices. In apparatuses other than the apparatuses which process musical tone signals such as the sound mixers and musical tone signal generating apparatuses, a similar problem can arise.

The present invention was accomplished to solve the above-described problem, and an object thereof is to provide a parameter setting apparatus which makes it easy for the user to position an operator of a movable operating device at a specified position.

In order to achieve the above-described object, it is a feature of the present invention to provide a parameter setting apparatus having a movable operating device which outputs a signal representative of a position of an operator which is moved by manual operation, the parameter setting apparatus setting a control parameter in accordance with a position of the operator, the parameter setting apparatus comprising a resistance imparting portion for imparting a resistance to manual operation of the operator; and a resistance controller for inputting a signal representative of a position of the operator from the movable operating device and controlling the imparting of a resistance by the resistance imparting portion such that the resistance continuously increases with increasing distance of the operator from a predetermined position or with increasing approach of the operator to a predetermined position.

The operator, which is a fader or a rotative operator, is suitable for setting a control parameter for use in a sound mixer or a musical tone signal generating apparatus. The operator can be also adopted for setting a control parameter in other apparatuses as well. In the sound mixer or the musical tone signal generating apparatus, the operator is used, for example, for setting a control parameter for control of an output level of signals, for setting a control parameter for control of an effect to be added to signals, and the like. Furthermore, the parameter setting apparatus may have a plurality of movable operating devices and a plurality of resistance imparting portions associated with the movable operating devices. In this case, the resistance controller separately controls the imparting of resistances by the plurality of resistance imparting portions.

In the present invention configured as described above, when the resistance controller controls the imparting of the resistance by the resistance imparting portion such that the resistance to be imparted to manual operation of the operator continuously increases with increasing distance of the operator from a predetermined position, a user's manipulation of moving the operator becomes harder as the operator moves away from the predetermined position. In this case, therefore, if a target position where the operator should be positioned is defined as the predetermined position, the user is allowed to perceive the amount of deviation from the target position of the operator as well as to know, when the user manipulates the operator, whether the manipulation moves the position of the operator away from the target position, or the manipulation moves the operator closer to the target position. As a result, the present invention makes it easy for the user to move the operator to the target position, making it hard for the user to move the operator to displace from the target position. In a case where the user intentionally moves the operator to displace from the target position, furthermore, the present invention ensures user's recognition of the displacement.

When the resistance controller controls the imparting of a resistance by the resistance imparting portion such that the resistance to be imparted to manual operation of the operator continuously increases with increasing approach of the operator to a predetermined position, a user's manipulation of moving the operator becomes harder as the operator moves close to the predetermined position. In this case, therefore, if an avoidance position where the operator should not be positioned is defined as the predetermined position, the user is allowed to perceive the amount of deviation from the avoidance position of the operator as well as to know, when the user manipulates the operator, whether the manipulation moves the position of the operator closer to the avoidance position, or the manipulation moves the operator away from the avoidance position. As a result, the present invention makes it easy for the user to avoid the avoidance position in moving the operator, making it hard for the user to move the operator toward the avoidance position. In a case where the user intentionally moves the operator toward the avoidance position, the present invention ensures user's recognition of the move toward the avoidance position.

Another feature of the present invention is that the resistance controller has a control data storing portion for storing a plurality of variation property control data sets provided in order to vary a resistance to be imparted to the operator according to its position with different properties; and the resistance controller selects any one of the plurality of variation property control data sets stored in the control data storing portion and controls the imparting of a resistance by the resistance imparting portion by use of the selected variation property control data.

In this case, the control data storing portion may store a plurality of variation property control data sets in association with a plurality of functions assigned to the movable operating device. Alternatively, the control data storing portion may store a plurality of variation property control data sets in association with a plurality of conditions where the movable operating device is used. Furthermore, the resistance controller may have resistance selector for selecting, in accordance with a specified function or condition, any one of the plurality of variation property control data sets stored in the control data storing portion so that the resistance controller controls the imparting of a resistance by the resistance imparting portion in accordance with the variation property control data selected by the resistance selector. The function assigned to the movable operating device include a function of setting a control parameter for controlling an output level of signals and a function of setting a control parameter for controlling an effect to be added to signals. In other words, objects to be controlled vary with control parameters specified according to the functions. The conditions where the movable operating device is used indicate circumstances, scenes, timings, etc. where the movable operating device is used for one function.

According to the another feature, even if a state where the movable operating device is used has been changed due to changes of either or both of the function and the condition, the present invention makes it easy for the user to move the operator toward a target position, also making it hard for the user to displace the operator away from a target position on the basis of the new state. In addition, the present invention makes it easy for the user to move the operator away from an avoidance position, also making it hard for the user to move the operator toward an avoidance position.

It is still another feature of the present invention to provide the parameter setting apparatus further comprising an automatic setting portion for automatically moving a position of the operator to a target position. In this case, the automatic setting portion may have a target position storing portion for storing a plurality of target position data sets representative of a plurality of target positions of the operator. For example, the target position storing portion may store a plurality of target position data sets representative of a plurality of target positions in association with a plurality of functions of the movable operating device. Alternatively, the target position storing portion may store a plurality of target position data sets representative of a plurality of target positions in association with a plurality of conditions where the movable operating device is used. Furthermore, the automatic setting portion may be provided with a target position selector for selecting, in accordance with a specified function or condition, any one of the plurality of target position data sets stored in the target position storing portion so that the automatic setting portion automatically moves the position of the operator in accordance with the target position data set selected by the target selector.

The still another feature eliminates user's manipulation of operator and achieves automatic setting of operator to its appropriate target position, improving the ease-of-use of the parameter setting apparatus. The parameter setting apparatus also allows the user to move the operator to from its target position to user's desired position, allowing user's setting to which user's intention is reflected. If the target position of the operator is provided in accordance with the function of the movable operating device or the condition where the movable operating device is used as described above, particularly, the still another feature enables the parameter setting apparatus to automatically set the position of the operator at its appropriate target position in accordance with the function of the movable operating device or the condition where the movable operating device is used, further improving the ease-of-use of the parameter setting apparatus.

In the parameter setting apparatus having the function of automatically moving the position of the operator, furthermore, when the resistance controller controls the imparting of a resistance by the resistance imparting portion such that the resistance continuously increases with increasing distance of the operator from a predetermined position, the target position may correspond with the predetermined position. When the resistance controller controls the imparting of a resistance by the resistance imparting portion such that the resistance continuously increases with increasing approach of the operator to a predetermined position, the target position may be apart from the predetermined position. After the automatic moving of the operator to its target position, as a result, the present invention makes it hard for the user to manipulate the operator to displace from the target position. Even if the operator has been displaced from its target position by the user, the present invention makes it easy for the user to manipulate the operator to return to its target position.

In addition to the invention of the parameter setting apparatus, the present invention can be also embodied as a computer program and a method for the parameter setting apparatus.

### BRIEF DESCRIPTION OF THE DRAWINGS

FIG. 1 is a block diagram showing an entire apparatus according to an embodiment of the present invention;

FIG. 2 is a functional block diagram realized by program processing on the apparatus shown in FIG. 1;

FIG. 3 is a schematic longitudinal sectional view showing an example movable operating device;

FIG. 4 is a top view showing part of FIG. 3;

FIG. 5(A) to FIG. 5(E) are graphs indicative of correlation between the position of an operator and a resistance with regard to a first resistance imparting method;

FIG. 6(A) to FIG. 6(E) are graphs indicative of correlation between the position of an operator and a resistance with regard to a second and a third resistance imparting methods;

FIG. 7 is a schematic longitudinal sectional view showing an example movable operating device for use in the third resistance imparting method;

FIG. 8 is a functional block diagram realized by program processing according to a modified example of FIG. 1;

FIG. 9 is a block diagram showing a main part of a sound mixer when the sound mixer is applied as a utilization apparatus:

FIG. 10 is a top view showing part of an operating panel of the sound mixer; and

FIG. 11 is a flowchart of a panel operation process program for controlling the sound mixer.

### DESCRIPTION OF THE PREFERRED EMBODIMENT

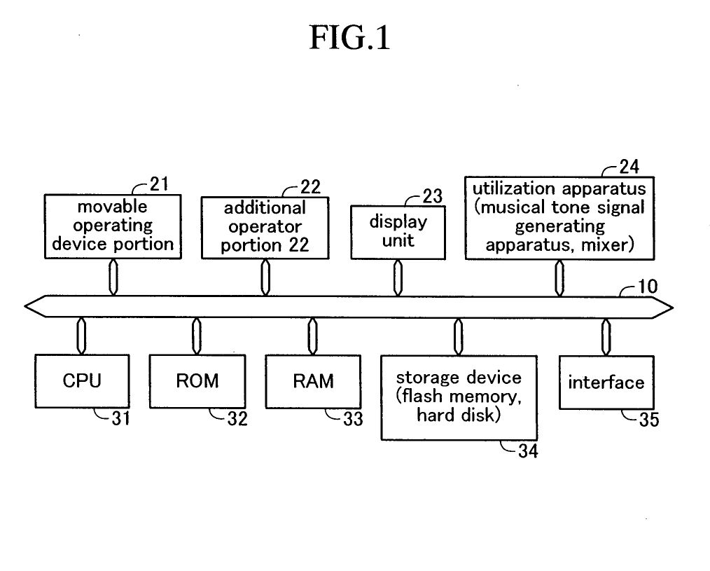

An embodiment of the present invention will now be described with reference to the drawings. FIG. 1 is a block diagram showing the hardware configuration of an entire apparatus including a parameter setting apparatus according to the present invention. The apparatus includes a movable operating device portion 21, an additional operator portion 22, a display unit 23 and a utilization apparatus 24 which are connected to a bus 10.

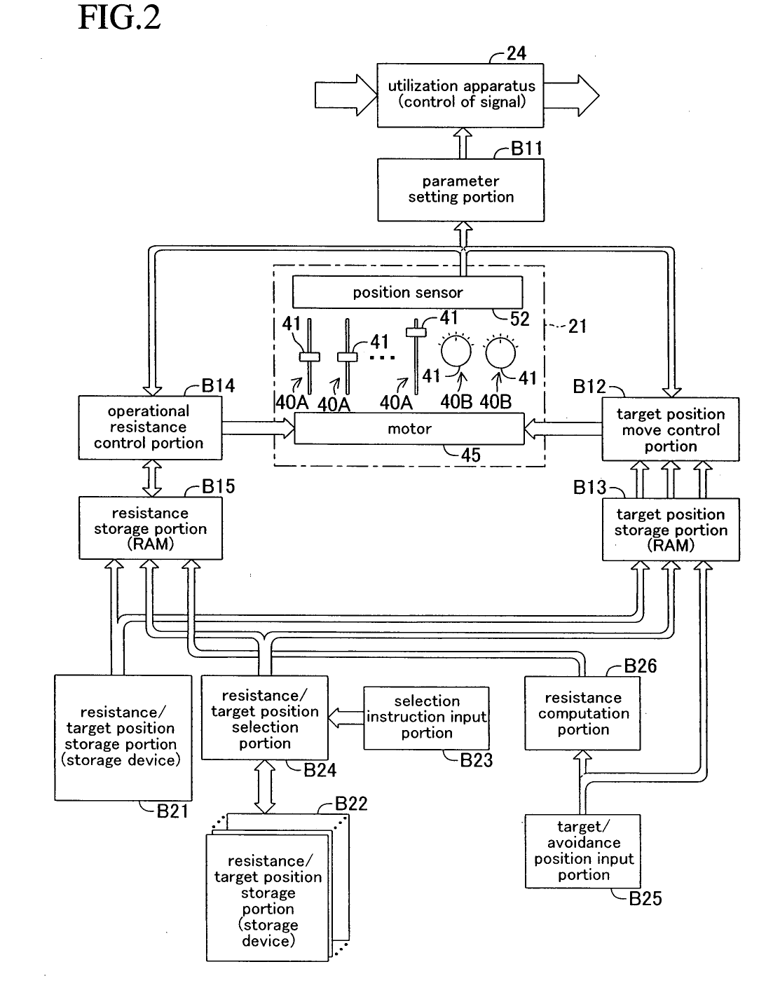

The movable operating device portion 21 includes a plurality of movable operating devices 40A, 40B as shown in FIG. 2. Each of the movable operating devices 40A has an operator 41 (fader) which is linearly moved. Each of the movable operating devices 40B has an operator 41 which is rotatively moved. These movable operating devices 40A, 40B are used in order to control the output level (mixing level) of signals such as musical tone signals and voice signals or in order to control various control elements (level or frequency of modulation signal, frequency characteristics of signals, etc.) of a sound effect to be added to the signals.

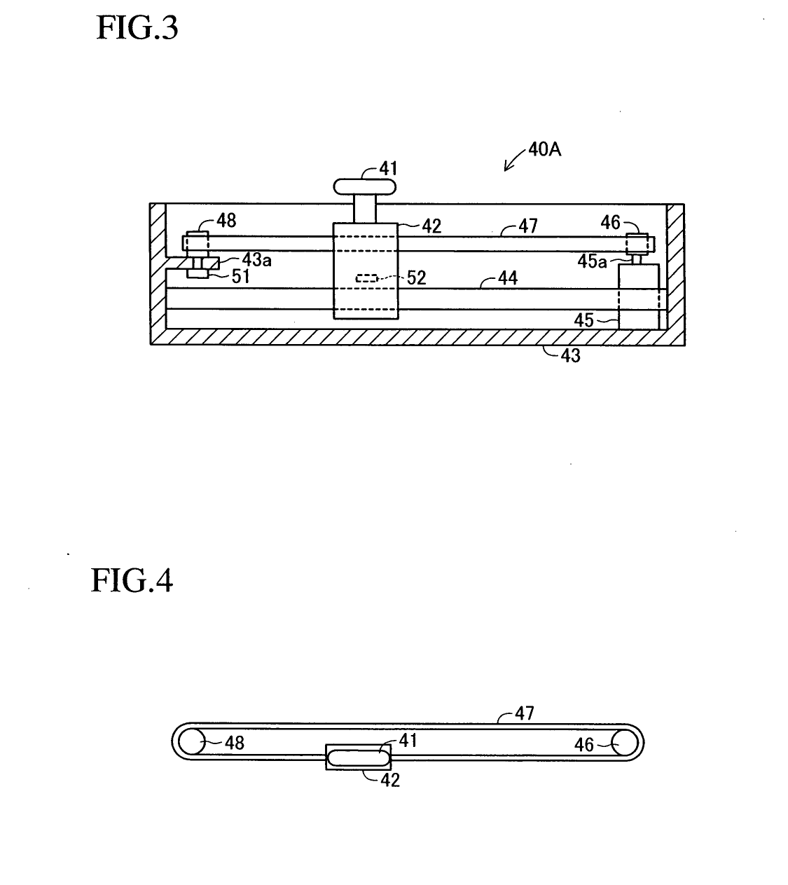

The movable operating device 40A will be briefly described, referring to a schematic longitudinal sectional view shown in FIG. 3. The movable operating device 40A has the operator 41 which is operated by a user. The operator 41 is fastened to the top face of a drive block 42, jutting above a housing 43. The drive block 42 is built on the outer circumference of a guide rod 44 whose edges are fixed to the lower part of the inside of the housing 43, being left movable along the axis line of the guide rod 44. The housing 43 accommodates a motor 45 used as a motorized actuator in the proximity of one edge of the guide rod 44. The motor 45 is equipped with a reduction gear to convey the rotation of the motor 45 to a rotational axis 45a via the reduction gear. To the outer circumference of the top end of the rotational axis 45a, a drive pulley 46 which rotates along with the rotational axis 45a is fastened.

As shown in FIG. 3 and FIG. 4, one end of a ring-shaped rubber belt 47 is wound on an outer circumferential surface of the drive pulley 46. The other end of the belt 47 is wound on an outer circumferential surface of a driven pulley 48. The driven pulley 48 is fixed to the top surface of a rotational base 51 which rotatably pierces through a base plate 43a which integrally juts from the inner surface of the housing 43. The upper part of the drive block 42 is fixed to the belt 47, so that the drive block 42 moves along the axis direction of the guide rod 44 integrally with the rotation of the belt 47. In synchronization with the rotation of the motor 45, as a result, the drive block 42 and the operator 41 move as well. By manual operation of the operator 41, in addition, the drive block 42 and the operator 41 also move.

The drive block 42 is equipped with a magnetic sensor 52. The magnetic sensor 52, which detects the position of the drive block 42 and the operator 41, is opposed to an unshown strip magnetic member which is fixed to the guide rod 44. The magnetic member extends along the axis direction of the guide rod 44, being composed of two rows of magnetic patterns in which the north pole and the south pole are alternately magnetized. One of the magnetic patterns is displaced by π/2 from the other magnetic pattern. A move of the drive block 42 causes the magnetic sensor 52 to output two trains of pulse signals having a phase difference of π/2 each other. The pulse train signals are used for calculation of the position of the drive block 42 and the operator 41. The calculation is actually carried out by later-described program processing performed by a CPU 31. More specifically, the operator 41 is set at an initial position at the time of the actuation thereof. On the basis of the amount of displacement and the displaced direction measured from the initial position, the position of the drive block 42 and the operator 41 is calculated. The magnetic sensor 52 may be replaced with an optical sensor.

The movable operating device 40B will not be described in detail with reference to drawings, however, the operator 41 of the movable operating device 40B is rotatively driven through a reduction gear by the rotary force of a motor. The operator 41 can be also rotated by manual operation. The movable operating device 40B also integrates a rotary position sensor (e.g., rotary encoder) to detect the rotary position of the operator 41.

The additional operator portion 22, which is composed of a plurality of on/off operators, are used to control operations of the entire apparatus and to generate control data. The display unit 23, which displays characters, graphics, and the like on a display screen, is composed of a liquid crystal display (LCD).

The utilization apparatus 24 utilizes parameters specified by the movable operating device portion 21. Examples of the utilization apparatus 24 include a sound mixer and an electronic musical instrument. The electronic musical instrument has at least a musical tone signal generation circuit, and can include performance operators such as a keyboard. On these sound mixer and electronic musical instrument, the parameters specified by use of the movable operating device portion 21 are used as control parameters for controlling the output level of musical tone signals and voice signals for a plurality of lines or channels, control parameters for controlling effects to be added to musical tone signals and voice signals, and control parameters for controlling frequency characteristics of musical tone signals and voice signals. The utilization apparatus is not limited to the sound mixer and the electronic musical instrument, but may be any apparatus as long as it can deal with parameters specified by use of the movable operating device portion 21.

The apparatus also has a CPU 31, a ROM 32, a RAM 33, a storage device 34 and an interface circuit 35 which are connected to the bus 10, respectively. The CPU 31, the ROM 32 and the RAM 33 configure a computer portion. The CPU 31 executes a later-described program. The ROM 32 stores various programs and data. The RAM 33 serves as a storage device for temporarily storing various kinds of data. The storage device 34 is composed of writable nonvolatile large-capacity storage media such as flash memory and hard disk, and drive units for the storage media. The storage device 34 stores various programs and various kinds of data. These data and programs may be previously stored in the storage device 34. Alternatively, these data and programs may be externally retrieved via the interface circuit 35. The interface circuit 35 allows the apparatus to connect to an external apparatus and the Internet.

Next, settings of parameters in the embodiment having the above-described configuration will be described with reference to FIG. 2. FIG. 2 is a functional block diagram showing parameter settings realized by program processing executed by the CPU 31 in collaboration with the hardware shown in FIG. 1. In FIG. 2, the motor 45 corresponds to a motor provided for the plurality of movable operating devices 40A, 40B, respectively. The position sensor 52, which includes the magnetic sensor 52 shown in FIG. 1, detects respective positions of the respective operators 41 of the plurality of movable operating devices 40A, 40B, and then outputs detection signals representative of the detected positions. In the functional block diagram of FIG. 2, the number of the movable operating devices 40A, 40B is equal to the number of objects to be controlled in the utilization apparatus 24. In accordance with the respective positions of the operators 41, the objects are controlled in the utilization apparatus 24 in a fixed manner.

Signals representative of the respective positions of the operators 41 are delivered to a parameter setting portion B11. The parameter setting portion B11, which is realized by program processing, produces a plurality of control parameters in accordance with a plurality of detection signals output by the position sensor 52, and outputs the produced control parameters to the utilization apparatus 24. At the time of the production of control parameters, the parameter setting portion B11 may directly output signals representative of the positions of the operators 41. Alternatively, the parameter setting portion B11 may convert the positions in accordance with previously stored properties before the output. In accordance with the respective positions of the operators 41, thus, the objects are controlled in the utilization apparatus 24.

The operators 41 are designed to be automatically moved to their respective target positions by a target position move control portion B12. The target position move control portion B12, which is realized by program processing, inputs signals representative of positions of the operators 41 from the position sensor 52. The target position move control portion B12 also inputs target position data representative of target positions stored in a target position storage portion B13, and performs feedback control of the rotation of the motor 45 so that the positions of the operators 41 correspond with their respective target positions. In the target position storage portion B13, which is a temporal storage portion provided in the RAM 33 shown in FIG. 1, target position data is stored by later-described processing. The target position move control portion B12 operates at the time of update of target position data stored in the target position storage portion B13. In other words, the target position move control portion B12 operates in response to instructions to move the operators 41 to their target positions. In any states other than the above, the target position move control portion B12 will never control the motor 45 to move the operators 41. In a state where the motor 45 is not controlled to drive by the target position move control portion B12, the operators 41 are moved by user's manipulation.

At the time of manual operation of the operator 41, an operational resistance control portion B14 imparts a resistance (reaction force) corresponding to the position of the operator 41 to the manual operation of the operator 41. The operational resistance control portion B14, which is realized by program processing, inputs signals representative of respective positions of the operators 41 from the position sensor 52. The operational resistance control portion B14 then reads out, from a resistance storage portion B15, resistance data representative of resistances corresponding to the respective positions, the resistance data being stored in the resistance storage portion B15. The operational resistance control portion B14 then controls the motor 45 to impart a resistance to the operators 41, respectively. In the resistance storage portion B15, which is also a temporal storage portion provided in the RAM 33 of FIG. 1, resistance data is stored by later-described processing.

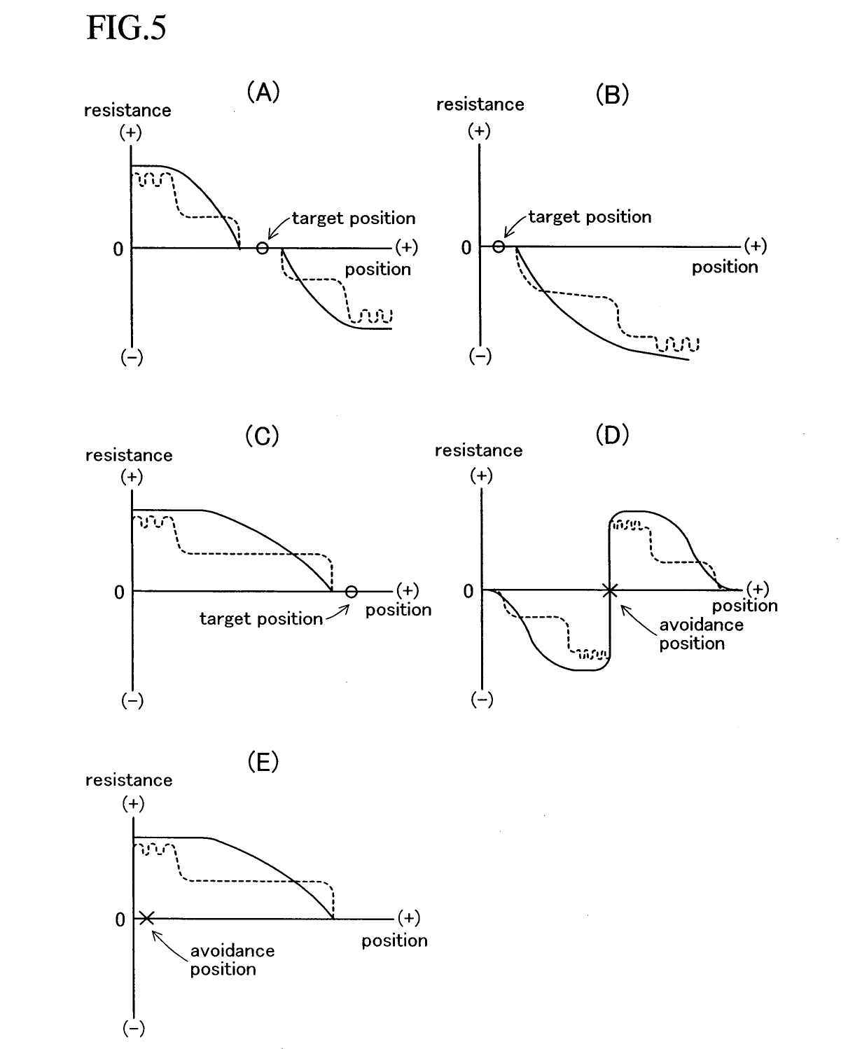

Next, a method for imparting a resistance by the operational resistance control portion B14 (a first resistance imparting method) will be described. In the resistance storage portion B15, a plurality of resistance tables are stored. The respective resistance tables store various kinds of resistances which vary with the position of the operators 41 in accordance with different properties. These different kinds of resistances are assigned to the different types of control parameters to be used by the utilization apparatus 24. In other words, the different kinds of resistances are assigned to the plurality of movable operating devices 40A, 40B, respectively. Solid lines shown in FIGS. 5(A) to 5(E) indicate variation properties of different kinds of resistances, respectively.

In FIGS. 5(A) to 5(E), the lateral axis indicates the position of an operator 41. The lateral axis defines the minimum position of the operator 41 as “0”, indicating varying positions of the operator 41 from “0” to the maximum position by a positive value which linearly increases from “0”. In the case of the movable operating device 40A, the minimum position of the operator 41 is the position where the operator 41 is positioned at the shown lowest position. In the case of the movable operating device 40B, the minimum position of the operator 41 is the position where the operator 41 is turned to the shown leftmost rotative position. In the case of the movable operating device 40A, the maximum position is the position where the operator 41 is positioned at the shown uppermost position. In the case of the movable operating device 40B, the maximum position is the position where the operator 41 is turned to the rightmost position. The vertical axis of FIGS. 5(A) to 5(E) indicates a resistance imparted to the operator 41. Positive resistance values indicate that a force proportional to the amount of an absolute value is imparted to the operator 41 in the direction of the maximum position of the operator 41. Negative resistance values indicate that a force proportional to the amount of an absolute value is imparted to the operator 41 in the direction of the minimum position of the operator 41. When a resistance is “0”, any force is not imparted to the operator 41.

A force to be imparted to the operator 41 by the motor 45 on the basis of the above-described resistance is smaller than the total value of a static friction force between the pulleys 46, 48 and the belt 47, a static friction force between the drive block 42 and the guide rod 44, and other static friction forces. More specifically, the force to be imparted to the operator 41 by the motor 45 is not strong enough to move the operator 41. Therefore, imparting of such a resistance to the operator 41 does not results in a move of the operator 41. In order to move the operator 41, the user is required to impart a force larger than a value in which the resistance is added to the friction forces. Under the control of the motor 45 by the operational resistance control portion B14, a resistance is thus imparted to user's operation of the operator 41.

Concrete descriptions about FIGS. 5(A) to 5(E) will now be given. Solid lines of FIG. 5(A) indicate a property in which as the position of the operator 41 moves from the minimum position to the vicinity of a median position, the resistance continuously and smoothly varies from a positive value of a larger absolute value to “0”, while as the position of the operator 41 moves from the vicinity of the median position to the maximum position, the resistance continuously and smoothly varies from “0” to a negative value of a larger absolute value. In the case of FIG. 5(A), the target position is the median position. In this case, if the operator 41 is positioned between the minimum position and the vicinity of the median position, a force helping the operator 41 move toward the median position is exerted on the operator 41. This force increases as the position of the operator 41 moves from the median position to the minimum position. If the operator 41 is positioned between the vicinity of the median position and the maximum position, a force helping the operator 41 move toward the median position is exerted on the operator 41. This force increases as the position of the operator 41 moves from the median position to the maximum position. According to the property indicated by the solid lines of FIG. 5(A), therefore, if the user manipulates the operator 41 to displace the operator 41 from the vicinity of the median position toward the minimum position or the maximum position, the resistance imparted to the user's manipulation of the operator 41 increases with increasing distance from the median position. If the user manipulates the operator 41 to displace the operator 41 from the minimum position or the maximum position toward the vicinity of the median position, on the other hand, an assistance force imparted to the user's manipulation of the operator 41 increases with increasing distance from the median position.

A solid line of FIG. 5(B) indicates a property in which as the position of the operator 41 moves from the vicinity of the minimum position toward the maximum position, the resistance continuously and smoothly varies from “0” to a negative value of a larger absolute value. In the case of FIG. 5(B), the target position is a value neighboring the minimum position. In this case, if the operator 41 is positioned somewhere other than the vicinity of the minimum position, a force helping the operator 41 move toward the minimum position is exerted on the operator 41. This force increases as the position of the operator 41 moves from the vicinity of the minimum position toward the maximum position. In the vicinity of the minimum position, the resistance is “0”. According to the property indicated by the solid line of FIG. 5(B), therefore, if the user manipulates the operator 41 to displace the operator from the vicinity of the minimum position toward the maximum position, the resistance imparted to the user's manipulation of the operator 41 increases with increasing distance from the vicinity of the minimum position. If the user manipulates the operator 41 to move the operator 41 toward the minimum position, on the other hand, the assistance force imparted to the user's manipulation of the operator 41 increases with increasing distance from the minimum position.

A solid line of FIG. 5(C) indicates a property in which as the position of the operator 41 moves from the vicinity of the maximum position toward the minimum position, the resistance continuously and smoothly varies from “0” to a positive value of a larger absolute value. In the case of FIG. 5(C), the target position is a value neighboring the maximum position. In this case, if the operator 41 is positioned somewhere other than the vicinity of the maximum position, a force helping the operator 41 move toward the maximum position is exerted on the operator 41. This force increases as the position of the operator 41 moves from the vicinity of the maximum position toward the minimum position. In the vicinity of the maximum position, the resistance is “0”. According to the property indicated by the solid line of FIG. 5(C), therefore, if the user manipulates the operator 41 to displace the operator from the vicinity of the maximum position toward the minimum position, the resistance imparted to the user's manipulation of the operator 41 increases with increasing distance from the vicinity of the maximum position. If the user manipulates the operator 41 to move the operator 41 toward the maximum position, on the other hand, the assistance force imparted to the user's manipulation of the operator 41 increases with increasing distance from the maximum position.

As described above, the resistance which follows any one of the properties shown by the solid lines of FIGS. 5(A) to 5(C) allows the user to perceive the amount of deviation from the target position of the operator 41 as well as to know, when the user manipulates the operator 41, whether the manipulation displaces the position of the operator 41 away from the target position, or the manipulation moves the operator 41 closer to the target position. As a result, the embodiment of the present invention makes it easy for the user to move the operator 41 to the target position, also making it hard for the user to move the operator 41 to displace from the target position. In a case where the user intentionally moves the operator 41 to displace from the target position, furthermore, the embodiment ensures user's recognition of the displacement.

A Solid line of FIG. 5(D) indicates a property in which as the position of the operator 41 moves from the minimum position toward the median position, the resistance continuously and smoothly varies from “0” to a negative value of a larger absolute value, while as the position of the operator 41 moves from the median position toward the maximum position, the resistance continuously and smoothly varies from a positive value of a larger absolute value to “0”. In the case of FIG. 5(D), an avoidance position is the median position. In this case, if the operator 41 is positioned between the minimum position and the vicinity of the median position, a force helping the operator 41 move toward the minimum position is exerted on the operator 41. This force increases as the position of the operator 41 moves from the minimum position to the median position. If the operator 41 is positioned between the median position and the maximum position, a force helping the operator 41 move toward the maximum position is exerted on the operator 41. This force decreases as the position of the operator 41 moves from the median position toward the maximum position. According to the property indicated by the solid line of FIG. 5(D), therefore, if the user manipulates the operator 41 to move the operator 41 from the minimum position or the maximum position toward the median position, the resistance imparted to the user's manipulation of the operator 41 increases with increasing approach to the median position. If the user manipulates the operator 41 to move the operator 41 from the median position toward the minimum position or the maximum position, on the other hand, the assistance force imparted to the user's manipulation of the operator 41 decreases with increasing distance from the median position.

A Solid line of FIG. 5(E) indicates a property in which as the position of the operator 41 moves from the minimum position toward the maximum position, the resistance continuously and smoothly varies from a positive value of a larger absolute value to “0”. In the case of FIG. 5(E), the avoidance position is a value neighboring the minimum position. In this case, if the operator 41 is positioned somewhere other than the maximum position, a force helping the operator 41 move toward the maximum position is exerted on the operator 41. This force increases as the position of the operator 41 moves from the maximum position toward the minimum position. At the maximum position, the resistance is “0”. According to the property indicated by the solid line of FIG. 5(E), therefore, if the user manipulates the operator 41 to move the operator from the maximum position toward the minimum position, the resistance imparted to the user's manipulation of the operator 41 increases with increasing distance from the maximum position. If the user manipulates the operator 41 to move the operator 41 toward the maximum position, on the other hand, the assistance force imparted to the user's manipulation of the operator 41 increases with increasing distance from the maximum position.

As described above, the resistance which follows either of the properties shown by the solid lines of FIGS. 5(D) and 5(E) allows the user to perceive the amount of deviation from the avoidance position of the operator 41 as well as to know, when the user manipulates the operator 41, whether the manipulation moves the position of the operator 41 closer to the avoidance position, or the manipulation moves the operator 41 away from the avoidance position. As a result, the embodiment of the present invention makes it easy for the user to avoid the avoidance position in moving the operator 41. In addition, the embodiment also makes it hard for the user to displace the operator 41 toward the avoidance position. In a case where the user intentionally displaces the operator 41 toward the avoidance position, the embodiment ensures user's recognition of the displacement toward the avoidance position.

Next, operations for storing target position data and resistance tables in the target position storage portion B13 and the resistance storage portion B15 will be described. The storing operation includes a first to third methods. In the first method, the target position and the resistance of the operators 41 are controlled in a fixed manner. In this method, a resistance/target position storage portion B21 previously stores a set of target position data and a resistance table which are associated with the plurality of movable operating devices 40A, 40B. The resistance/target position storage portion B21 is provided in a certain storage area of the storage device 34. The target position data and the resistance table are stored in resistance/target position storage portion B21 prior to shipment of this apparatus, or are externally retrieved via the interface circuit 35 to be stored. Alternatively, the target position data and the resistance table can be generated or selected to be stored in the resistance/target position storage portion B21 by the user at the use of this apparatus.

On start of this apparatus (that is, at power-on of this apparatus) or on user's instruction by use of the additional operator portion 22, the target position data and the resistance table (see solid lines of FIGS. 5(A) to 5(E)) stored in the resistance/target position storage portion B21 are transferred to the target position storage portion B13 and the resistance storage portion B15. Concurrently with the transfer, the target position move control portion B12 and the operational resistance control portion B14 are activated to perform the above-described operation. Resultantly, the plurality of operators 41 of the plurality of movable operating devices 40A, 40B are automatically moved to their respective target positions in accordance with the target position data. To the operators 41, a resistance is to be imparted, respectively, in accordance with the resistance table. The target position data is not provided for all the operators 41 (e.g., target position data is not provided for operators which are provided with an avoidance position such as the solid lines of FIGS. 5(D), 5(E)). For the operators 41 which are not provided with the target position data, therefore, the target position move control portion B12 does not carry out the control for moving the operators to their target position. In the later-described second and third methods as well, the target position move control portion B12 does not carry out the control for moving the operators which are not provided with target position data to their target positions.

The second method for storing target position data and a resistance table in the target position storage portion B13 and the resistance storage portion B15 will be described. In the second method, the target position and the resistance of the operators 41 are controlled in a manner which varies depending on user's choice. In the second method, sets of target position data and resistance tables which are similar to those of the first method are provided. A resistance/target position storage portion B22 stores the various kinds of target position data sets and resistance tables. The resistance/target position storage portion B22 is also provided in the certain storage area of the storage device 34. The target position data and resistance tables are stored in the resistance/target position storage portion B22 in a manner similar to that of the first method. Each of the target position data sets and resistance tables are composed of a different data group. The various target position data sets and the resistance tables are provided for various conditions such as various circumstances, scenes, and timings where this apparatus including the movable operating devices 40A, 40B is utilized.

In the second method, a selection instruction input portion B23 and a resistance/target position selection portion B24 realized by program processing are provided. The selection instruction input portion B23 inputs instructions which are selected by the user by use of the additional operator portion 22, and delivers the user's instructions to the resistance/target position selection portion B24. In response to the delivered instructions, the resistance/target position selection portion B24 selects a set of the target position data and a resistance table from among different sets of target position data and resistance tables stored in the resistance/target position storage portion B22, and stores the selected target position data and the resistance table in the target position storage portion B13 and the resistance storage portion B15, respectively. Concurrently with the storing of the data and table, the target position move control portion B12 and the operational resistance control portion B14 are activated to perform the above-described operation. Resultantly, the plurality of operators 41 of the plurality of movable operating devices 40A, 40B are automatically moved to their respective target positions in accordance with the target position data. To the operators 41, a resistance is to be imparted, respectively, in accordance with the resistance table. According to the second method, as a result, the respective target positions of the operators 41 of the movable operating devices 40A, 40B are variously switched in accordance with conditions in which the apparatus is utilized, while the respective resistances of the operators 41 are variously specified in accordance with the conditions in which the apparatus is utilized.

The third method for storing target position data and a resistance table in the target position storage portion B13 and the resistance storage portion B15 will be described. In the third method, the target position and the avoidance position of the operators 41 are specified by the user. In the third method, in addition, a resistance table is automatically created in accordance with the user's specified target positions and avoidance positions. In the third method, a target/avoidance position input portion B25 and a resistance computation portion B26 which are realized by program processing are provided. The target/avoidance position input portion B25 inputs target position data and avoidance position data representative of user's specified target positions and avoidance positions, and then inputs the target position data and the avoidance data to the resistance computation portion B26, while delivering the target position data to the target position storage portion B13. In the third method, the user manipulates the additional operator portion 22 to input the target positions or avoidance positions of the operators 41 of the movable operating devices 40A, 40B.

The resistance computation portion B26 creates a resistance table which stores resistance data representative of respective resistances of the operators 41 of the movable operating devices 40A, 40B on the basis of the input target position data or avoidance position data. The resistance computation portion B26 then stores the created resistance table in the resistance storage portion B15. The resistance data of the respective operators 41 represents respective resistances which vary with the position of the operators 41 as shown by the solid lines of FIGS. 5(A) to 5(E). By use of previously stored parameters, the resistance computation portion B26 calculates respective resistances of the operators 41 on the basis of the input target position data so that the resistances of the respective operators 41 are associated with their positions. More specifically, the resistance computation portion B26 calculates resistances such that a larger operational reaction force is exerted on the operators 41 as the position of the operators 41 displaces from the target position, while a larger assistance force is exerted on the operators 41 as the position of the operators 41 moves close to the target position as shown by the solid lines of FIGS. 5(A) to 5(C). The resistance computation portion B26 calculates respective resistances of the operators 41 on the basis of the input avoidance position data so that the resistances of the respective operators 41 are associated with their positions. More specifically, the resistance computation portion B26 calculates resistances such that a larger operational reaction force is exerted on the operators 41 as the position of the operators 41 moves close to the avoidance position, while a larger assistance force is exerted on the operators 41 as the position of the operators 41 moves away from the avoidance position as shown by the solid lines of FIGS. 5(D) and 5(E).

In the third method as well, concurrently with the storing of data in the target position storage portion B13 and the resistance storage portion B15, the target position move control portion B12 and the operational resistance control portion B14 are activated to perform the above-described operation. Resultantly, the plurality of operators 41 of the plurality of movable operating devices 40A, 40B are automatically moved to their respective target positions in accordance with the target position data. To the operators 41, a resistance is to be imparted, respectively, in accordance with the resistance table. According to the third method, as a result, on the basis of user's specification of target positions and avoidance positions, resistances adequate for the user's specified target positions and avoidance positions are automatically provided for the operators 41 of the movable operating devices 40A, 40B.

In the above descriptions, the resistance which continuously and smoothly varies with the position of the operator 41 is imparted to the operator 41 as shown by the solid lines of FIGS. 5(A) to 5(E). As long as the resistance varies continuously, however, the resistance may have a property in which the resistance varies stepwise as shown by broken lines of FIGS. 5(A) to 5(E). In areas where the resistance is large, in addition, the resistance may have a property in which the resistance slightly fluctuates as shown by the broken lines of FIGS. 5(A) to 5(E). According to this property, user's manipulation of the operator 41 in these areas causes intermittently fluctuated resistance, ensuring user's recognition that the position of the operator 41 falls within an area which is not recommended.

In the above descriptions, in addition, the respective operators 41 of the movable operating devices 40A, 40B are provided with a resistance at all times. In other words, the motor 45 is energized at all times. Instead of the above-described scheme, however, the apparatus may have a sensor for detecting a user's touch of the operators 41 so that the motor 45 is energized to impart a resistance only when the apparatus detects a user's touch of the operators 41.

In the above descriptions, in addition, a resistance to an operation to be imparted to the operators 41 of the movable operating devices 40A, 40B is limited to the range in which the operators 41 are not moved by the resistance. However, the apparatus may be modified such that in a case where the resistance is insufficient, the apparatus detects, on the basis of detection signals of the position sensor 52, a displacement which moves the operator 41 away from the target position or a displacement which moves the operator 41 toward the avoidance position, controls, in response to the detection, the motor in order to move the operator 41 in the direction opposite to the direction in which the operator 41 is displaced, and imparts a resistance to the operation of the operator 41.

(Second Method for Imparting Resistance)

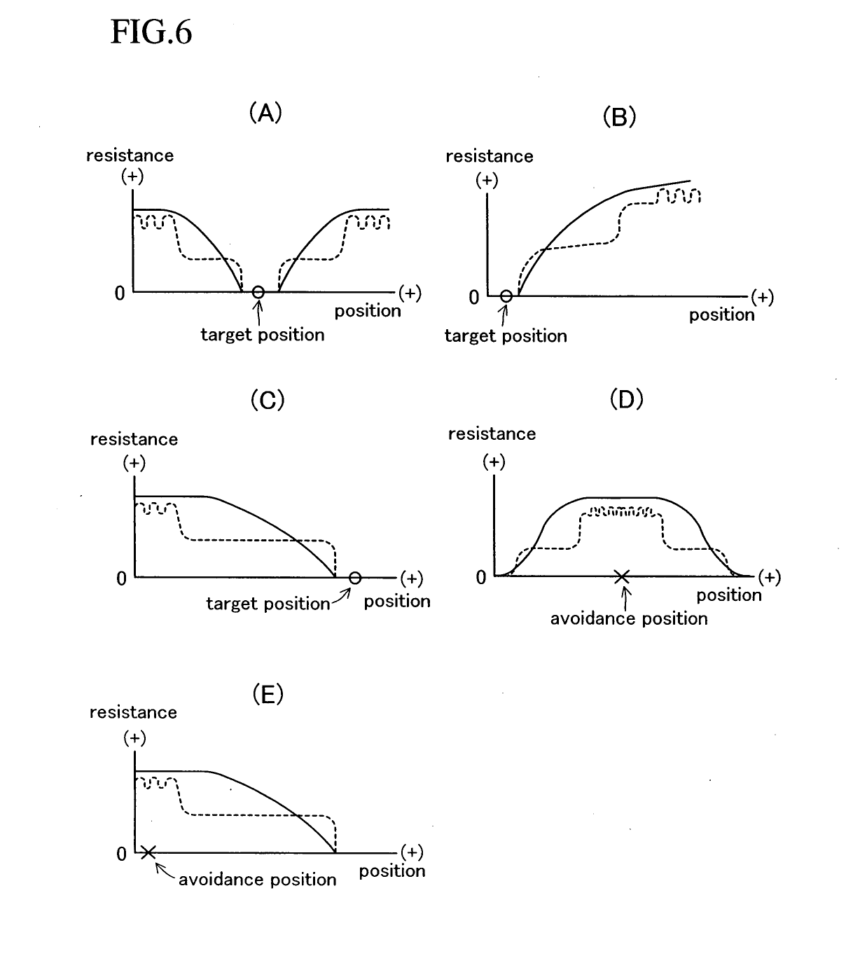

In the above descriptions, the first resistance imparting method in which a resistance is imparted to an operation of the operators 41 by imparting a rotational force in one direction to the motor 45 within a range in which the operator 41 is not displaced is described. However, the first method may be replaced with a second or third method for imparting a resistance to the operators 41 of the movable operating devices 40A, 40B. In the second method, a static magnetic field which disturbs rotation of a rotor of the motor 45 is imparted to the rotor of the motor 45. The magnitude of the static magnetic field is proportional to a resistance. In the second method, as shown by the solid lines of FIGS. 6(A) to 6(C), when the operator 41 is provided with a target position, the energization of the motor 45 is controlled such that the static magnetic field (a resistance) is imparted to the rotor of the motor 45 so that the resistance continuously and smoothly decreases with increasing approach to the target position, and increases with increasing distance from the target position. As shown by the solid lines of FIGS. 6(D) and 6(E), when the operator 41 is provided with an avoidance position, the energization of the motor 45 is controlled such that the static magnetic field (a resistance) is imparted to the rotor of the motor 45 so that the resistance continuously and smoothly decreases with increasing distance from the avoidance position, and increases with increasing approach to the avoidance position.

The second method also produces an effect similar to that produced by the first resistance imparting method which facilitates user's manipulation of the operator 41 when the operator is positioned in the vicinity of the target position or at a distance from the avoidance position, and hinders user's manipulation of the operator 41 when the operator is positioned at a distance from the target position or in the vicinity of the avoidance position. However, the second resistance imparting method also hinders even user's manipulation of the operator 41 of approaching the target position or moving away from the avoidance position once the operator 41 has been displaced by the user to any position from the target position or to the vicinity of the avoidance position. For these cases, therefore, the apparatus may be designed to detect a move of the operator 41 toward the target position or away from the avoidance position and remove the static magnetic field (resistance) in response to such detection.

In the second resistance imparting method as well, the resistance may have a property in which the resistance varies stepwise as shown by broken lines of FIGS. 6(A) to 6(E). In areas where the resistance is large, in addition, the resistance may have a property in which the resistance slightly fluctuates as shown by the broken lines of FIGS. (A) to 5(E). In order to prevent constant energization of the motor 45, in addition, the apparatus may have a sensor for detecting a user's touch of the operators 41 so that the motor 45 is energized to impart a resistance only when the apparatus detects a user's touch of the operators 41. In order to prevent insufficient resistance, furthermore, the apparatus may be modified such that the apparatus detects, on the basis of detection signals of the position sensor 52, a displacement which moves the operator 41 away from the target position or a displacement which moves the operator 41 toward the avoidance position. The apparatus controls, in response to the detection of such a displacement, the motor in order to move the operator 41 in the direction opposite to the direction in which the operator 41 is displaced, and imparts a resistance to the operator 41.

(Third Resistance Imparting Method)

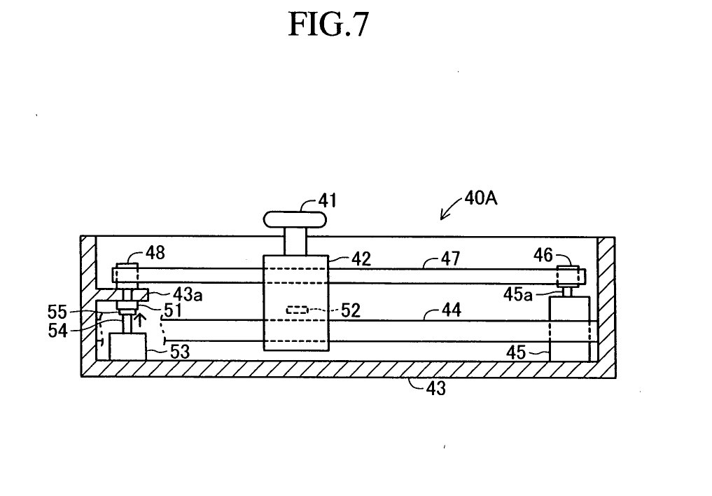

Next, the third method for imparting a resistance will be described. In the third method, a mechanical resistance is imparted to the rotation of the belt 47 caused by the motor 45. As shown in FIG. 7, the movable operating device 40A is provided with a motorized linear actuator 53. By the linear actuator 53, a drive rod 54 is pushed upwardly to press a friction member 55 fastened to the top surface of the drive rod 54 against the rotational base 51 to impart a resistance to the rotation of the driven pulley 48. In the third method as well, the linear actuator 53 is electrically controlled to control, in accordance with the position of the operator 41, a force which pushes the drive rod 54 upwardly as shown by the solid lines of FIGS. 6(A) to 6(C).

Similarly to the second resistance imparting method, the third method also produces the effect of the first resistance imparting method which facilitates user's manipulation of the operator 41 when the operator is positioned in the vicinity of the target position or at a distance from the avoidance position, and hinders user's manipulation of the operator 41 when the operator is positioned at a distance from the target position or in the vicinity of the avoidance position. However, the third resistance imparting method also hinders even user's manipulation of the operator 41 of approaching the target position or moving away from the avoidance position once the operator 41 has been displaced by the user to any position from the target position or to the vicinity of the avoidance position. For these cases, therefore, the apparatus may be designed to detect a move of the operator 41 toward the target position or away from the avoidance position and release contact of the friction member 55 with the rotational base 51 in response to such detection.

Instead of imparting a resistance to the rotation of the rotational base 51, the third resistance imparting method may be modified to contact a friction member with part of the belt 47 to impart a resistance to the rotation of the belt 47. In addition to the rotational base 51 and the belt 47, a resistance may be imparted to any member as long as the member is displaced in association with the rotation of the belt 47.

In the third resistance imparting method as well, the resistance may have a property in which the resistance varies stepwise as shown by broken lines of FIGS. 6(A) to 6(E). In areas where the resistance is large, in addition, the resistance may have a property in which the resistance slightly fluctuates as shown by the broken lines of FIGS. 6(A) to 6(E). In order to prevent constant energization of the motor 45, in addition, the apparatus may have a sensor for detecting a user's touch of the operators 41 so that the linear actuator 53 is energized to impart a resistance only when the apparatus detects a user's touch of the operators 41. Furthermore, the third resistance imparting method may be adopted along with the first or the second resistance imparting method.

(Modification with Switching of Functions of Operators)

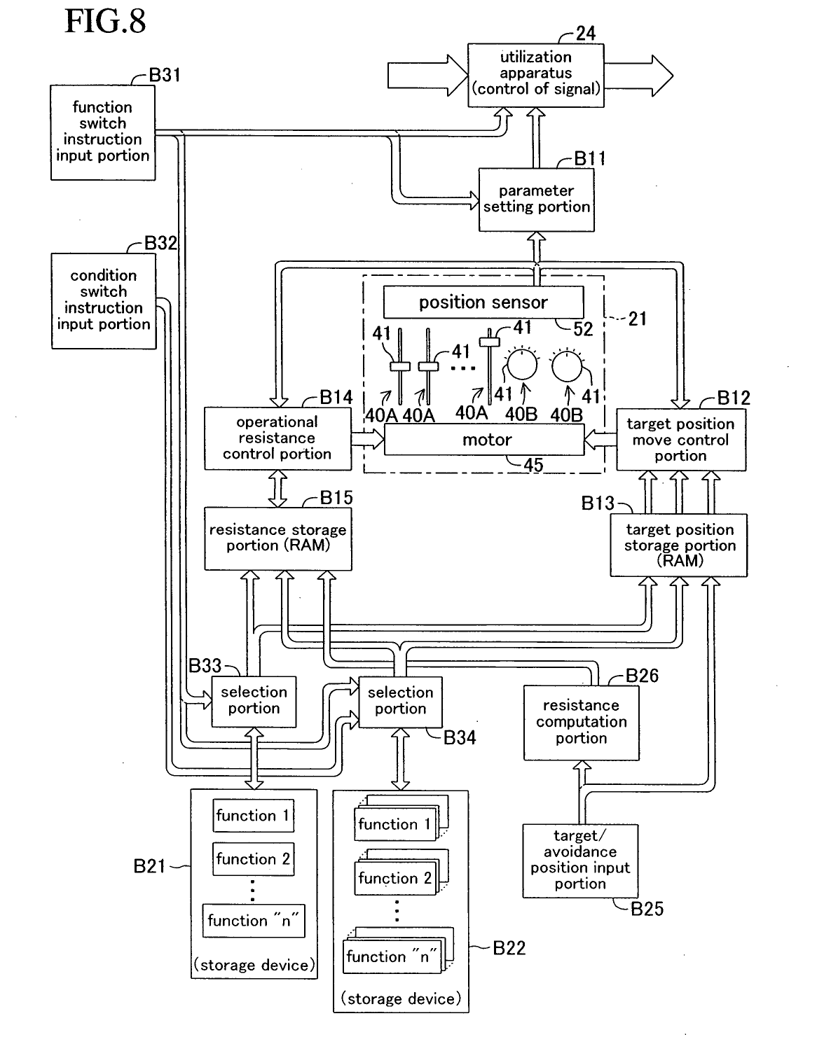

Referring to a functional block diagram of FIG. 8, a modified example which enables switching of functions assigned to the movable operating devices 40A, 40B will be described. The functional block diagram of FIG. 8 shows a modification obtained by modifying part of the functional block diagram of FIG. 2. In this modification, the number of the movable operating devices 40A, 40B is fewer than that of the objects controlled in the utilization apparatus 24. More specifically, the movable operating devices 40A, 40B are used for a plurality of objects belonging to a control object group selected from among a plurality of control object groups provided for the utilization apparatus 24. The control objects provided for the utilization apparatus 24 include output level of a plurality of signals and a plurality of control elements to be used for effects to be added to signals.

In this modified apparatus, the resistance/target position storage portions B21, B22 are configured similarly to those of the above-described embodiment, and achieve functions similar to those of the embodiment. However, the resistance/target position storage portion B21 of the modified apparatus stores a set of target position data and resistance table provided for a plurality of functions (control object groups), the target position data and resistance table being associated with the plurality of movable operating devices 40A, 40B. The resistance/target position storage portion B22 stores sets of target position data and resistance tables provided for the functions (control object groups), the sets of target position data and resistance tables being provided for various conditions as in the case of FIG. 2. The storing of the target position data set and resistance table is done similarly to that of the above descriptions.

The modified apparatus also includes a function switch instruction input portion B31 and a condition switch instruction input portion B32 which are realized by program processing. The function switch instruction input portion B31 inputs a function (a control object group) specified by the user through the use of the additional operator portion 22 and delivers signals representative of the specified function to the utilization apparatus 24, the parameter setting portion B11 and selection portions B33, B34, respectively. The condition switch instruction input portion B32 inputs conditions (circumstances, scene, timing, etc.) specified by the user through the use of the additional operator portion 22 and delivers signals representative of the specified conditions to the selection portion B34. In accordance with the respective positions of the operators 41 of the movable operating devices 40A, 40B detected by the position sensor 52, the parameter setting portion B11 produces control parameters for a plurality of control objects assigned to the plurality of movable operating devices 40A, 40B on the basis of the specified function. Using the control parameters produced by the parameter setting portion B11, the utilization apparatus 24 controls the control objects assigned to the movable operating devices 40A, 40B on the basis of the specified function.

In accordance with the signals representative of the specified function, the selection portion B33 selects the set of target position data and the resistance table stored in the resistance/target position storage portion B21 and stores the selected data set and table in the target position storage portion B13 and the resistance storage portion B15. In accordance with the signals representative of the specified function and the specified conditions, the selection portion B34 selects a set of target position data and a resistance table stored in the resistance/target position storage portion B22 and stores the selected data set and table in the target position storage portion B13 and the resistance storage portion B15. The other constituents of the functional block diagram shown in FIG. 8 are similar to those of the functional block diagram of FIG. 2. More specifically, respective target positions and resistances of the operators 41 are controlled by the target position move control portion B12 and the operational resistance control portion B14, respectively, on the basis of the target position data stored in the target position storage portion B13 and the resistance table stored in the resistance storage portion B15. In contrast to the above-describe embodiment, according to this modified example, as a result, respective target positions and resistances of the operators 41 are appropriately controlled in response to switching among the functions and conditions.

(Concrete Example Applied to Sound Mixer)

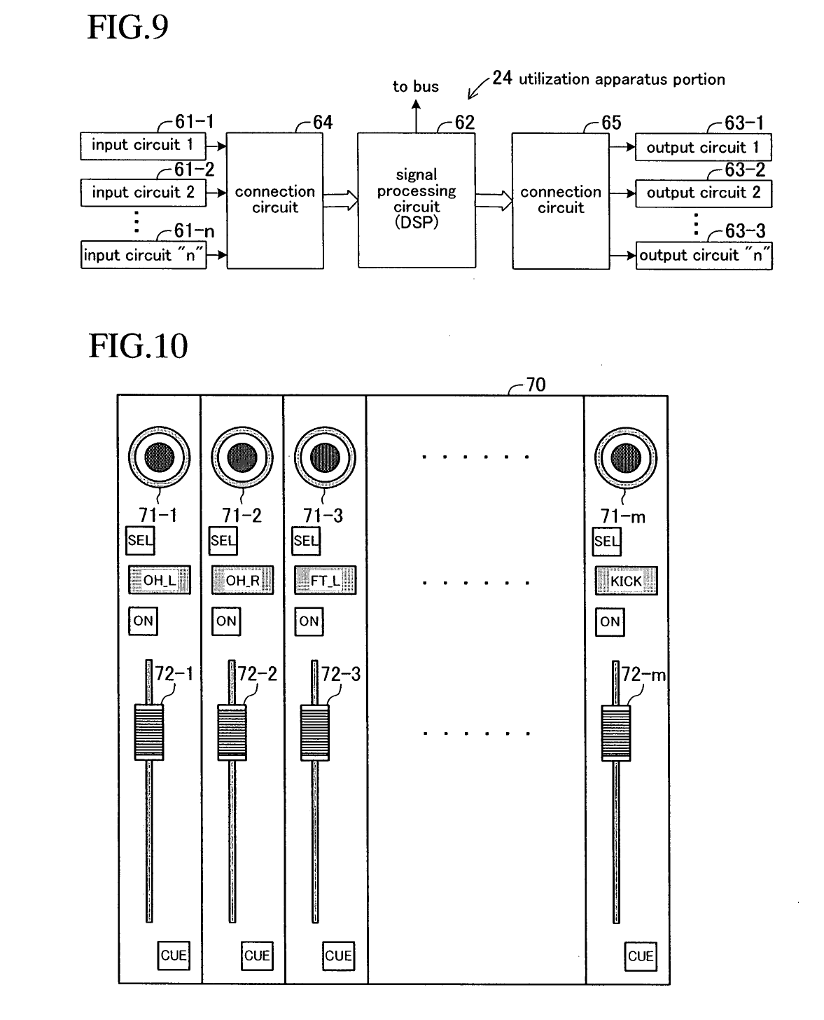

Next, a concrete embodiment of a sound mixer to which the present invention is applied will be described. FIG. 9 shows example circuits contained in the utilization apparatus 24 shown in FIG. 1. The utilization apparatus 24 has a plurality of input circuits 61-1 to 61-n, a signal processing circuit 62 and a plurality of output circuits 63-1 to 63-n. The respective input circuits 61-1 to 61-n externally input a plurality of analog signals and digital signals. When analog signals are input, the inputs circuits 61-1 to 61-n convert the analog signals to digital signals before output. The signal processing circuit 62 has a plurality of signal processing channels for digital form. Each signal processing channel, which is composed of an equalizer circuit, a level control circuit, etc., controls the frequency characteristic, the signal level and the like of the input digital signal, and outputs the controlled digital signals. The number of signal processing channels of the signal processing circuit 62 is fewer than the number of signals which can be input to the input circuits 61-1 to 61-n. For instance, the number of the signal processing channels is nearly equal to the number of signals which each of the input circuits 61-1 to 61-n can input.

The respective output circuits 63-1 to 63-n output a plurality of digital signals and analog signals. In order to output analog signals, the output circuits 63-1 to 63-n convert digital signals delivered from the signal processing circuit 62 to analog signals, and output the converted signals. Between the input circuits 61-1 to 61-n and the signal processing circuit 62 and between the signal processing circuit 62 and the output circuits 63-1 to 63-n, connection circuits 64, 65 are connected. The connection circuit 64 selectively connects input signals input from the input circuits 61-1 to 61-n to the plurality of signal processing channels of the signal processing circuit 62. The connection circuit 65 selectively connects output signals output from the signal processing channels of the signal processing circuit 62 to the output circuits 63-1 to 63-n.

An operating panel of this apparatus is provided with an operating portion 70 shown in FIG. 10. The operating portion 70 is separated into areas each corresponding to a signal processing channel of the signal processing circuit 62. Each area is provided with one of rotative operators 71-1 to 71-m and one of faders 72-1 to 72-m. Each area is also provided with other operators and indicators. The rotative operators 71-1 to 71-m are provided for pan control. The rotative operators 71-1 to 71-m may be automatically driven by a motor as the movable operating device 40B of the above-described embodiment, however, the rotative operators 71-1 to 71-m of this modified example are designed to be moved only by user's manipulation. The faders 72-1 to 72-m, which are provided for control of signal level, correspond to the operators 41 of the movable operating devices 40A of the above-described embodiment.

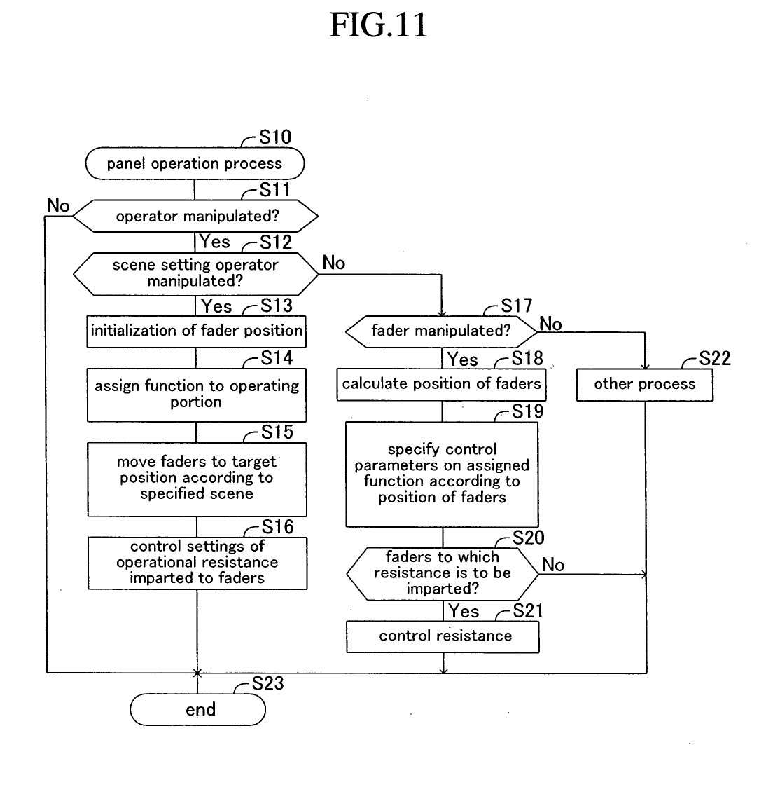

In this modified example, furthermore, the additional operator portion 22 shown in FIG. 1 is also provided with scene setting operators for specifying, in accordance with scene, conditions, etc., input signals to be controlled by the operating portion 70 and the target position of the faders 72-1 to 72-m. The specification by use of the scene setting operators corresponds to concurrent specification of function and conditions described in the above embodiment. In this modified example as well as the case of the modified example of FIG. 8, the storage device 34 has the resistance/target position storage portion B22 which stores target position data sets and resistance tables provided for a plurality of functions, the target position data sets and resistance tables being provided for a plurality of conditions (scenes). In this modified example, the storage device 34 also stores a panel operation process program shown in FIG. 11.

In the modified example configured as described above, when the power of the apparatus is turned on to initiate the apparatus, the CPU 31 starts repeating execution of the panel operation process program every certain short time period. The panel operation process program is started in step S10 of FIG. 11. If none of the operators of the operating panel including the operating portion 70 has been manipulated, the CPU 31 makes a negative determination in step S11 to temporarily terminate the execution of this program in step S23. If any of the operators has been manipulated, on the other hand, the CPU 31 makes a positive determination in step S11 to carry out processes of step S12 and later.

Assume that a scene setting operator has been manipulated. In this case, the CPU 31 makes a positive determination in step S12 and initializes the fader position of the operating portion 70 in step S13. In the initialization of the fader position, the motor 45 is controlled to drive such that the faders 72-1 to 72-m move to a predetermined initial position (e.g., minimum position). In the initialization of the fader position, furthermore, position data representative of the position of the faders 72-1 to 72-m stored in the RAM 33 is initialized to the value representative of the minimum position of the faders 72-1 to 72-m. In step S14, the CPU 31 assigns a function to the respective areas of the operating portion 70 including the faders 72-1 to 72-m in accordance with the scene specified by the scene setting operator. More specifically, the CPU 31 controls the connection circuit 64 of FIG. 9 to selectively input signals input to the input circuits 61-1 to 61-n to the signal processing channels of the signal processing circuit 62 in accordance with the specified function. Concurrently with the input of the signals, the CPU 31 also controls the connection circuit 65 in accordance with the specified function to specify to which output circuits 63-1 to 63-n the signals processed by the signal processing circuit 62 are output.

After step S14, the CPU 31 moves, in step S15, the faders 72-1 to 72-m to their target positions in accordance with the specified scene (conditions). As already explained in the descriptions about the above-described modified example, more specifically, the CPU 31 reads out target position data corresponding to the function and conditions identified by the specified scene from the resistance/target position storage portion B22, and controls the driving of the motor 45 to move the faders 72-1 to 72-m to their respective target positions represented by the target position data. Furthermore, the CPU 31 adds displacement amount of the faders 72-1 to 72-m detected by the position sensor 52 to the value representative of the position of the faders 72-1 to 72-m stored as the initial settings in the RAM 33 to obtain the position of the faders 72-1 to 72-m, and then performs feedback control of the motor 45 in accordance with the obtained position. This processing corresponds to the processing of the target position storage portion B13 and the target position move control portion B12 of FIG. 8.

In step S16, the CPU 31 controls the settings of resistance to be imparted to an operation of the faders 72-1 to 72-m in accordance with the specified scene (conditions). As explained in the descriptions about the above-described embodiment, in this case as well, the CPU 31 reads out resistance data associated with the position of the faders 72-1 to 72-m stored in a resistance table corresponding to the function and conditions identified by the specified scene from the resistance/target position storage portion B22. Then, a resistance is to be imparted to the faders 72-1 to 72-m in accordance with the respective positions of the faders 72-1 to 72-m by any one of the above-described first to third resistance imparting methods or by combination of these methods. This processing corresponds to the processing done by the resistance storage portion B15 and the operational resistance control portion B14 of FIG. 8.

If the faders 72-1 to 72-m are operated, the CPU 31 makes a positive determination in step S17, and then calculates the position of the faders 72-1 to 72-m in step S18. As the above-described case, in this calculation, the CPU 31 obtains the position of the faders 72-1 to 72-m by adding position data representative of the current position of the faders 72-1 to 72-m stored in the RAM 33 to the displacement amount of the faders 72-1 to 72-m detected by the position sensor 52, and then updates the position data stored in the RAM 33. In step S19, the CPU 31 then calculates control parameters on the specified function in accordance with the calculated position of the faders 72-1 to 72-m, and outputs the calculated control parameters to the signal processing circuit 62. This processing corresponds to the processing done by the parameter setting portion B11 of FIG. 8. The processing for setting control parameters causes the signal processing circuit 62 to process input signals in accordance with the delivered control parameters to output the processed signals.

After step S19, the CPU 31 carries out processes of steps S20, S21 to impart an operational resistance to the operated faders 72-1 to 72-m on condition that the operated faders 72-1 to 72-m are defined as the faders to be provided with a resistance. The resistance is imparted in a manner similar to that of the case of the above-described step S16. If any operator other than the scene operators and the faders 72-1 to 72-m is operated, the CPU 31 proceeds to step S22 to carry out a process on the operator.

In this modified example as well, as explained in the above descriptions, an operational resistance is imparted to the faders 72-1 to 72-m in accordance with the position with respect to the their respective target positions as in the case of the modification of FIG. 8. Furthermore, a change to the scene (function and conditions) causes automatic positioning of the faders 72-1 to 72-m to their respective target positions as well as a change to the resistance in accordance with the changed scene. As a result, this modified example also realizes an effect similar to the modification of FIG. 8.

Furthermore, it will be understood that the present invention is not limited to the above-described embodiment, but various modifications may be made without departing from the spirit and scope of the invention.

What is claimed is:

1. A parameter setting apparatus having a movable operating device which outputs a signal representative of a position of an operator which is moved by manual operation, the parameter setting apparatus setting a control parameter in accordance with a position of the operator, the parameter setting apparatus comprising:
a resistance imparting portion for imparting a resistance to manual operation of the operator; and
a resistance controller for inputting a signal representative of a position of the operator from the movable operating device and controlling the imparting of a resistance by the resistance imparting portion such that the resistance continuously increases with increasing distance of the operator from a predetermined position or with increasing approach of the operator to a predetermined position.

2. A parameter setting apparatus according to claim 1, wherein
the operator is a fader or a rotative operator.

3. A parameter setting apparatus according to claim 1, wherein
the operator sets a control parameter for use in a sound mixer or a musical tone signal generating apparatus.

4. A parameter setting apparatus according to claim 1, further comprising a motor, wherein
the resistance imparting portion imparts a resistance to manual operation of the operator by imparting a rotational force in one direction to the motor or imparting a magnetic field for disturbing rotation of the motor to the motor.

5. A parameter setting apparatus according to claim 1, wherein
the resistance imparting portion imparts a resistance to manual operation of the operator by contacting a friction member with a member displaced in association with displacement of the operator.

6. A parameter setting apparatus according to claim 1, wherein
the resistance controller controls imparting of a resistance which fluctuates in areas where the resistance is large.

7. A parameter setting apparatus according to claim 1, further comprising a sensor for detecting a user's touch of the operator, wherein
the resistance controller controls imparting of a resistance only when the user's touch of the operator is detected by the sensor.

8. A parameter setting apparatus according to claim 1, wherein
the resistance controller has a control data storing portion for storing a plurality of variation property control data sets provided in order to vary a resistance to be imparted to the operator according to its position with different properties; and
the resistance controller selects any one of the plurality of variation property control data sets stored in the control data storing portion and controls the imparting of a resistance by the resistance imparting portion by use of the selected variation property control data.

9. A parameter setting apparatus according to claim 8, wherein
the control data storing portion stores a plurality of variation property control data sets in association with a plurality of functions assigned to the movable operating device;
the resistance controller has a resistance selector for selecting any one of the plurality of variation property control data sets stored in the control data storing portion in accordance with a specified function; and
the resistance controller controls the imparting of a resistance by the resistance imparting portion in accordance with the variation property control data selected by the resistance selector.

10. A parameter setting apparatus according to claim 9, wherein
the plurality of functions include at least either one of a function of setting a control parameter for controlling an output level of signals and a function of setting a control parameter for controlling an effect to be added to signals.

11. A parameter setting apparatus according to claim 8, wherein
the control data storing portion stores a plurality of variation property control data sets in association with a plurality of conditions where the movable operating device is used;
the resistance controller has a resistance selector for selecting any one of the plurality of variation property control data sets stored in the control data storing portion in accordance with a specified condition; and
the resistance controller controls the imparting of a resistance by the resistance imparting portion in accordance with the variation property control data selected by the resistance selector.

12. A parameter setting apparatus according to claim 11, wherein
the plurality of conditions include at least one of a circumstance, a scene and a timing where the movable operating device is used.

13. A parameter setting apparatus according to claim 1, further comprising:
an automatic setting portion for automatically moving a position of the operator to a target position.

14. A parameter setting apparatus according to claim 13, wherein
the automatic setting portion has a target position storing portion for storing a plurality of target position data sets representative of a plurality of target positions of the operator;
the automatic setting portion has a target position selector for selecting any one of the plurality of target position data sets stored in the target position storing portion; and
the automatic setting portion automatically moves a position of the operator in accordance with the target position data set selected by the target position selector.

15. A parameter setting apparatus according to claim 14, wherein
the plurality of target positions are associated with a plurality of functions assigned to the movable operating device; and
the target position selector selects any one of the plurality of target position data sets stored in the target position storing portion in accordance with a specified function.

16. A parameter setting apparatus according to claim 15, wherein
the plurality of functions include at least either one of a function of setting a control parameter for controlling an output level of signals and a function of setting a control parameter for controlling an effect to be added to signals.

17. A parameter setting apparatus according to claim 14, wherein
the plurality of target positions are associated with a plurality of conditions where the movable operating device is used; and
the target position selector selects any one of the plurality of target position data sets stored in the target position storing portion in accordance with a specified condition.

18. A parameter setting apparatus according to claim 17, wherein
the plurality of conditions include at least one of a circumstance, a scene and a timing where the movable operating device is used.

19. A parameter setting apparatus according to claim 13, wherein
the target position corresponds with a predetermined position when the resistance controller controls the imparting of a resistance by the resistance imparting portion such that the resistance continuously increases with increasing distance of the operator from the predetermined position.

20. A parameter setting apparatus according to claim 13, wherein
the target position is apart from a predetermined position when the resistance controller controls the imparting of a resistance by the resistance imparting portion such that the resistance continuously increases with increasing approach of the operators to the predetermined position.
